(19) United States
(12) Patent Application Publication
(10) Pub. No.: US 2012/0308784 A1
(43) Pub. Date: Dec. 6, 2012

(54) ADHESIVE PAD

(76) Inventor: Albert CHEN, Los Angeles, CA (US)

(21) Appl. No.: 13/209,404

(22) Filed: Aug. 14, 2011

Related U.S. Application Data
(63) Continuation-in-part of application No. 13/152,312, filed on Jun. 3, 2011.

(51) Int. Cl. C09J 7/02; C09J 109/06; C09J 115/00; B32B 7/12; B32B 3/10

(52) U.S. Cl. 428/195.1; 428/355 R; 428/355 EN; 428/355 BL; 428/354

(57) ABSTRACT

A flexible adhesive pad has a tacky elastomeric back layer made of a first naphthenic oil-impregnated thermoplastic rubber, an intermediary layer made of a polymer film permanently adhered to the elastomeric back layer by a first oil-based adhesive, and a tacky elastomeric front layer made of a second naphthenic oil-impregnated thermoplastic rubber adhered to the intermediary layer by a second oil-based adhesive. The front layer is transparent and the intermediary layer may has graphics or text viewable through the front layer that indicate a device that the front layer is intended to receive, and/or where on the front layer that device is intended to be received.

### RELATED APPLICATION

This application is a Continuation-in-Part of pending U.S. Utility patent application Ser. No. 13/152,312, filed on Jun. 3, 2011, the entire teachings thereof being incorporated herein by reference.

### FIELD OF THE INVENTION

The present invention is generally related to adhesive pads. More specifically, the field of the invention as embodied in the present disclosure is related to a planar pad that is adhesive on both faces to most surfaces, is removable there-from without leaving residue behind, has use-indicative graphics or text, and is reusable. Even more specifically, the field of the invention as embodied in the present disclosure is related to such a double-sided reusable sheet that is adhesive enough to removably and repeatedly adhere such massive items as cell phones, personal digital assistants (PDAs), GPS devices, and MP3 players to a vertical surface, in which the items are more easily removed from the pad than the pad is removed from the surface.

### BACKGROUND

Double-sided adhesives are well known, and are typically marketed in tape form or as adhesive pads for permanently affixing an item to a flat surface. Such double-sided adhesive tapes and pads include a flexible base layer in a continuous tape strip or in a rectangular sheet. Such tapes and pads have numerous drawbacks and disadvantages. Such drawbacks and disadvantages include the leaving behind of adhesive residue on the surface or the causing of damage to the surface when the tape or pad is removed. This is typically due to the qualities of the adhesives needed to provide adequate anti-gravitational support for massive objects to a wide range of vertical surfaces.

In order that these prior art tapes and pads could be useful with an unpredictably wide range of potential surfaces and objects, the adhesives needed to be strong and had to have a wide adherence spectrum. Such adhesives typically hardened over time or bonded to the surface or object as strongly as they bonded to the base layer of the tape or pad. Such adhesives are, naturally, difficult to remove from the surfaces they were adhered to.

“Sticky Tack” is a generic term for a tacky pliable amorphous and homogenous gel adhesive that may be molded by the user into a glob, string, or layer and used to hold objects to surfaces in a fashion similar to double-sided tape, except having removability and reusability. According to Wikipedia (http://en.wikipedia.org/wiki/Blu-Tack), other names for this material are “Blu-Tack, “Prestik”, “Sticky Stuff”, “Teacher's Chewing Gum”, “Tack-it”, “Buddies”, “Pritt-Tack”, “Poster Putty”, “Tac 'N Stick”, “Ticky Tack”, “White Tack”, and “Elmer's Tack.” While this material is removable and reusable, it cannot maintain a defined shape, so it cannot be formed into a permanently-shaped pad or be marked with graphics to indicate its intended purpose or provide any useful or entertaining image. Also, because it is homogenous, its adherence is inherently equal on both sides, and it just as easily removes from a surface as an object is removed from it. This results in the adhesive oftentimes peeling inadvertently from the surface, either in whole or in part, when only the object is intended to be removed.

There exists a need for improved versatility in adhesive pads, and such is an object of the present invention. There exists a need for added convenience in the use of adhesive pads, and such is an object of the present invention. There exists a need for improved attachment to a variety of surfaces by adhesive pads, and such is an object of the present invention. There exists a need for improved removal from those surfaces and reuse in adhesive pads, and such is an object of the present invention. There exists a need for elimination of residue left when such adhesive pads are removed from such surfaces, and such is an object of the present invention. There exists the need for such adhesive pads to have a permanent shape and/or markings indicative of their intended use or purpose, and such are objects of the present invention. There exists the need for such adhesive pads to more strongly adhere to the surfaces than objects adhere to the pads, and such is an object of the invention. Further needs and objects exist which are addressed by the present invention, as may become apparent by the included disclosure of an exemplary embodiment thereof.

### SUMMARY OF THE INVENTION

The invention may be embodied in an adhesive pad that may be permanently shaped similar to and sized to receive a small electronic object such as a cell phone, PDA, GPS device, or MP3 player. The pad may have graphics or text embedded there-in or printed thereon that indicate the object that it is intended to receive, and where on the pad that object is intended to be received. The pad may be inherently tacky and thereby adhesive on both its front and back faces, its back face being adapted for adhesion to a wide array of horizontal, vertical, or inclined flat surfaces, and its front face being adapted for adhesion to either a specific or a variety of such electronic objects or equivalent devices. The adhesiveness if the back face to the surface may be sufficient to hold the pad to the surface, whether the surface is vertically or horizontally disposed and to withstand not only the gravitational forces on the object and pad, but also to withstand the removal forces of the object being removed from the front face. The adhesiveness of the front face to the object may be sufficient to retain the object to the pad against the forces of gravity even when the pad is vertically disposed, yet may be weaker than the adhesiveness of the back face, enough to allow removal of the object from the pad without inadvertently peeling the pad from the surface. Alternatively, the graphics may inspire the user to position of the object centrally on the front face so that removal of the object will not cause peeling of the back face from the surface.

The invention may be embodied in an adhesive pad having an adhesive back layer made of a first oil-impregnated thermoplastic rubber, and an adhesive front layer made of a second oil-impregnated thermoplastic rubber permanently adhered to the back adhesive layer. The first and second oil-impregnated thermoplastic rubbers may be identical. Alternatively, the back and front layers may be permanently affixed to an intermediary layer. The front layer may be transparent and the intermediary layer may include graphics or text viewable through the front layer that indicate a device that the front layer is intended to receive, and/or a location on the front layer where the device is intended to be received. The location on the front layer where the device is intended to be received may be centrally on the front layer. The intermediary layer may additionally provide structural qualities unavailable in the thermoplastic rubbers of the back and front layers. The front layer may have a textured surface to reduce its adhesiveness to the device. The texturing may reduce the adhesiveness of the front layer to below the adhesiveness of the back layer.

The intermediary layer may be made of a polymer film from the group of materials including polycarbonate, polyethylene, and polyethylene-terephthalate. The thermoplastic rubbers may be from the group including styrene thermoplastic elastomer, styrene-butadiene-styrene block copolymer, and styrene-ethylene-butadiene-styrene block copolymer. The impregnating oils may be from the group including hydrogenated naphthenic oil, mineral oil, and a combination of hydrogenated naphthenic oil and mineral oil. The adhesive layers may comprise one-hundred parts thermoplastic rubber by weight, one-hundred to three-hundred parts hydrogenated naphthenic oil by weight, one-hundred to three-hundred parts mineral oil by weight, less than ten parts petroleum tackifier resin by weight, and one to five parts polypropylene resin by weight.

The invention may alternatively be embodied in a flexible adhesive pad having a tacky elastomeric back layer made of a first naphthenic oil-impregnated thermoplastic rubber, an intermediary layer made of a polymer film permanently adhered to the elastomeric back layer by a first oil-based adhesive, and a tacky elastomeric front layer made of a second naphthenic oil-impregnated thermoplastic rubber permanently adhered to the intermediary layer by a second oil-based adhesive. The first and second naphthenic oil-impregnated thermoplastic rubbers may be identical. The first and second oil-based adhesives may be identical. The front layer may be transparent and the intermediary layer may have graphics or text viewable through the front layer that indicate a device that the front layer is intended to receive, and/or a location on the front layer where the device is intended to be received. The location on the front layer where the device is intended to be received may be approximately centrally on the front layer.

The intermediary layer may additionally provide structural qualities unavailable in the thermoplastic rubbers of the back and front layers. The front layer may have a textured surface to reduce its adhesiveness to the device. The texturing may reduce the adhesiveness of the front layer to below the adhesiveness of the back layer.

The intermediary layer may be made of a polymer film from the group of materials including polycarbonate, polyethylene, and polyethylene-terephthalate. The thermoplastic rubbers may be from the group including styrene thermoplastic elastomer, styrene-butadiene-styrene block copolymer, and styrene-ethylene-butadiene-styrene block copolymer. The naphthenic impregnating oils may be from the group including hydrogenated naphthenic oil, mineral oil, and a combination of hydrogenated naphthenic oil and mineral oil. The adhesive layers may comprise one-hundred parts thermoplastic rubber by weight, one-hundred to three-hundred parts hydrogenated naphthenic oil by weight, one-hundred to three-hundred parts mineral oil by weight, less than ten parts petroleum tackifier resin by weight, and one to five parts polypropylene resin by weight.

The graphics and/or text may indicate positioning of an object centrally on the front layer so that removal of the object will not cause peeling of the back face from a surface to which the back face is adhered.

The invention may alternatively be embodied as an adhesive pad having an adhesive back layer, an adhesive front layer, and graphics and/or text viewable on or through the front layer and indicating that an object should be adhered to the front layer approximately centrally thereon. The adhesive back layer may be made of a first oil-impregnated thermoplastic rubber and the adhesive front layer may be made of a second oil-impregnated thermoplastic rubber, and the front layer may be transparent. The pad may further include an intermediary layer permanently adhered to and between the adhesive back and front layers. The intermediary layer may include the graphics and/or text viewable through the transparent front layer. The intermediary layer may be a polymer film from the group of materials including polycarbonate, polyethylene, and polyethylene-terephthalate. The graphics and/or text may be a field having a closed peripheral border.

Further features and aspects of the invention are disclosed with more specificity in the Detailed Description and Drawings of an exemplary embodiment provided herein.

### BRIEF DESCRIPTION OF THE DRAWINGS

Many aspects of the invention can be better understood with reference to the following drawings showing the representative embodiment of the accompanying Detailed Description. The components in the drawings are not necessarily to scale, emphasis instead being placed upon clearly illustrating the principles of the invention. Moreover, in the drawings, like reference numerals designate corresponding parts throughout the several views.

FIG. 1 is a perspective view of an adhesive pad according to an exemplary embodiment of the invention;

FIG. 2 is a face view of the adhesive pad of FIG. 1 with its back face adhered to a vertical wall and a cell phone adhered to its front face;

FIG. 3 is a side view of the adhesive pad of FIG. 1 with its back face adhered to a vertical wall and a cell phone adhered to its front face;

FIG. 4 is an exploded view of the adhesive pad of FIG. 1;

FIG. 5 is a top view of the adhesive pad of FIG. 1 with its back face adhered to a vertical wall and a cell phone adhered to its front face; and

FIG. 6 is an exploded side view of the adhesive pad, wall, and cell phone of FIG. 3.

### DETAILED DESCRIPTION OF A REPRESENTATIVE EMBODIMENT

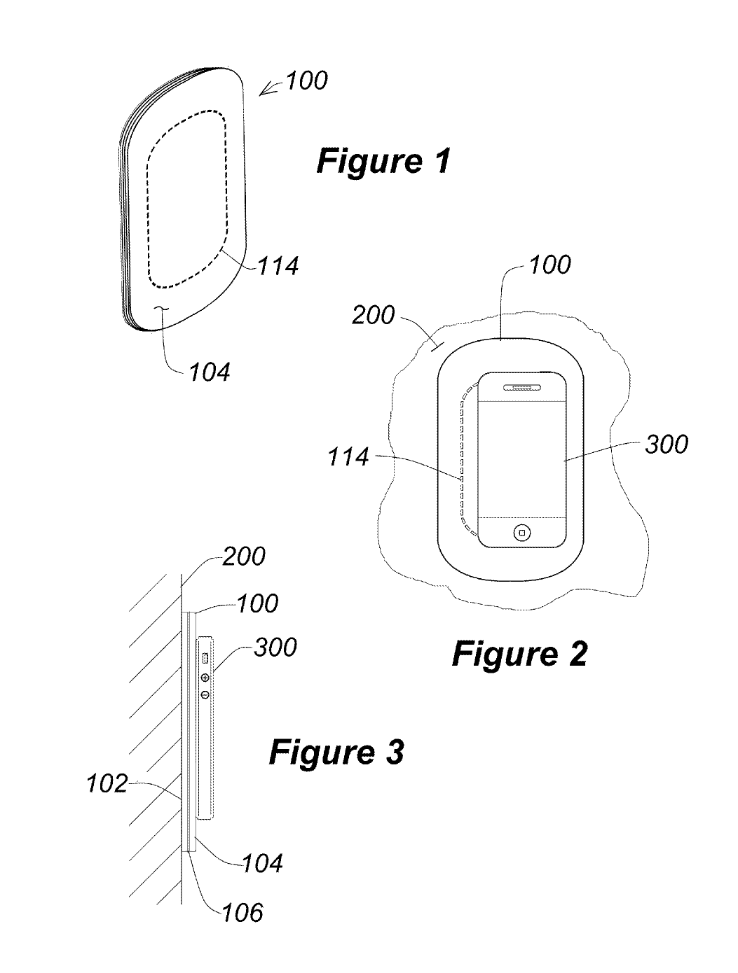

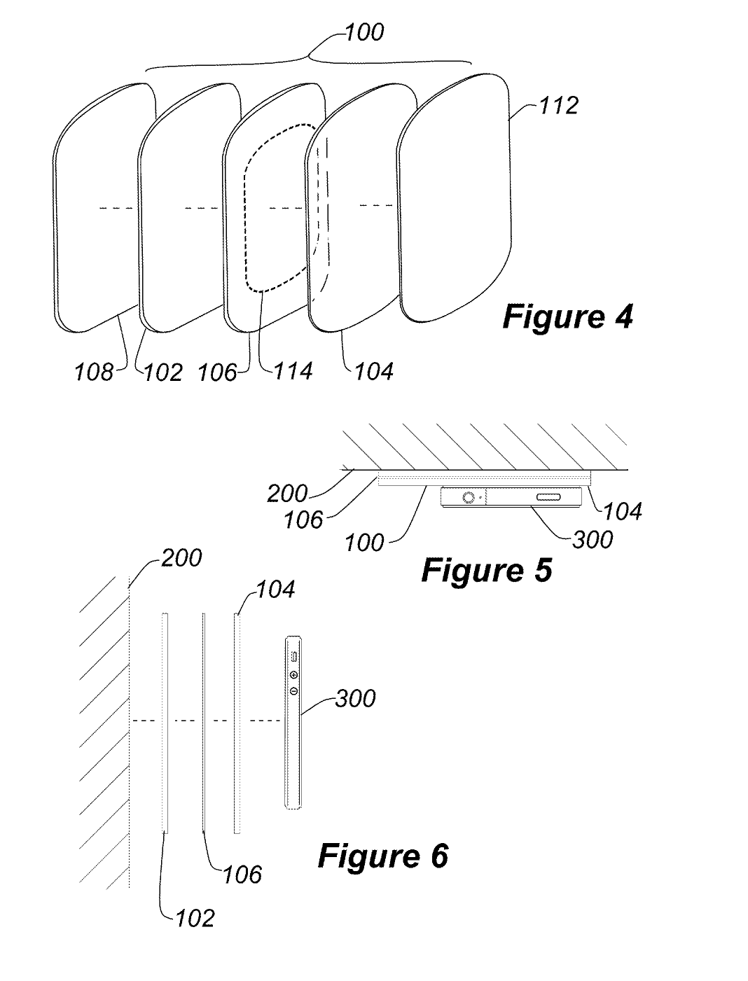

Referring to FIGS. 1 and 4, an adhesive pad 100 according to an exemplary embodiment of the present invention includes a back adhesive layer 102, a front adhesive layer 104, and an intermediary layer 106. Also included are a back contact sheet 108 and a front contact sheet 112 which are each temporarily adhered to the respective faces of the adhesive sheets during shipping or storage of the adhesive pad.

The front and back adhesive layers are preferably each made of a homogenous oil-enhanced thermoplastic rubber polymer material (TPR). The preferred material is further described below, but a myriad of similar materials may be substituted therefore, so long as those provide equivalent adherence and removal performance. The qualities of this material may differ in each adhesive layer, as explained below. The front and back adhesive layers are permanently bound to the intermediary layer, preferably by an oil-based adhesive coating 106 there-between. The material of at least the front layer is preferably somewhat transparent.

The contact sheets are both preferably a wax or silicone impregnated paper material or a plastic film that removably adheres to the adhesive layers equivalently to the intended adherence of the adhesive layer to other surfaces, so that the contact sheets can be applied at manufacturing and can protect the adhesive layers during shipping, and can then be easily peeled from the adhesive layers prior to use of the pad. No glue is used between the contact sheets and the adhesive layers, so that the contact sheets adhere to the adhesive layers by the adhesive properties of the adhesive layers only, and is easily peelable there-from. PET, PP, and PE films are found to be acceptable materials for the contact sheets. The contact sheets are removed and disposed of just prior to using the pad, or may be saved for reuse if the pad is to be stored.

The intermediary layer is preferably made of a polymer film that is permanently bondable to the adhesive layers and that is capable of having graphics applied thereto or there-in. Polycarbonate (PC) film is preferred. Poly-vinyl-chloride (PVC). Polyethylene (PE), Polypropylene (PP) or Polyethylene-terephthalate (PET) films are acceptable alternatives. The film is preferably thick enough to provide a degree of rigidity to the pad, but thin enough to be flexible to allow the pad to be peeled from a surface. The above-listed materials in a thickness range of 1 to 3 mm are found to perform effectively for these purposes.

The intermediary layer is permanently imprinted or embedded with graphics that define a shape and area which guides the user in adhering the object to the front layer. The graphics are viewable through the transparent front layer. Less preferably, the front layer could be non-transparent and include the graphics.

In the exemplary embodiment, which is intended to support a typical cell phone 300 against a vertical wall 200, these graphics in the intermediary layer take the form of a dotted-line outline 114 having the approximate shape and size of a typical cell phone, such as cell phone 300. The outline is positioned interior of the perimeter of the pad, to inspire the user to adhere the cell phone to the center of the front face and away from the perimeter of the pad. This lessens the chance that when the cell phone is peeled from the front face, the perimeter of the back face will not be inadvertently peeled form the wall. In effect. This reduces the adherence of the cell phone to the pad compared to the adherence of the pad to the wall so that the pad remains on the wall was the cell phone is repeatedly removed and replaced.

Alternatively, reduced adherence of the front layer to an object may be realized by texturing of the tacky face of the front layer to reduce its effective tackiness by reducing the tacky surface area that contacts the object compared to the surface area of the back layer that contacts the wall, assuming that the adhesive qualities of the front and back surfaces may or may not be identical in such an alternative embodiment.

As another alternative, the adhesive qualities of the front and back layer may be different to reduce the adhesiveness of the front layer compared to that of the back layer. As earlier stated, the adhesive layers are preferably a thermoplastic rubber (TPR), and most preferably a styrene thermoplastic elastomer (STPE) version of a TPR, such as a styrene-butadiene-styrene block copolymer (SBS) or a styrene-ethylene-butadiene-styrene block copolymer (SEBS). This preferably homogenous layer of thermoplastic material is impregnated with a hydrogenated naphthenic oil for its permanent tackiness. The back layer may be made tackier relative to the front layer by increasing the amount of oil therein in comparison to the amount of oil in the front layer. Or other established material variations may be used to alter the adhesiveness of one of the layers compared to the other.

The adhesive layers may be comprised of one-hundred parts SEBS by weight, one-hundred to three-hundred parts hydrogenated naphthenic oil by weight, one-hundred to three-hundred parts white (mineral) oil by weight, less than ten parts petroleum tackifier resin by weight, and one to five parts PP resin by weight. Such SEBS may be Kraton Polymers LLC G series, or China Yueyang Baling Petrochemical Co., Ltd. Huaxing Y H series, or some equivalent. Alternatively, an acceptable SBS may be Kraton Polymers LLC D series, or some equivalent.

The hydrogenated naphthenic oil preferably constitutes one-hundred-fifty to three hundred parts of the adhesive layer by weight, more preferably two-hundred to two-hundred-eighty parts by weight. This oil may be PetroChina Karamay Petrochemical Company's KNH series or NK series, or some equivalent.

The white (mineral) oil preferably constitutes one-hundred-fifty to three hundred parts of the adhesive layer by weight, more preferably two-hundred to two-hundred-eighty parts by weight.

The petroleum tackifier resin may be for example, C9 petroleum resin, C5 petroleum resin, C5/C9 copolymerized petroleum resin, or double glutaric thin (DCPD) resin. The tackifier resin preferably constitutes less than ten parts of the adhesive layer by weight, more preferably three to eight parts.

The PP resin may be improved by the addition of additives, including but not limited to plasticizers (such as paraffin or PE oligomers), antioxidants (such as calcium carbonate or silica), light stabilizers and UV stabilizers (such as UV-P and UV-320). These additives preferably constitute four to eight parts of the adhesive layer by weight.

Preferably, the adhesive strength of the adhesive layers is between 0.1 and 0.6 N/cm, the layer thicknesses are between 0.1 and 2.0 mm, and materials have a Shore A hardness of less than 20 degrees. This adhesive can be reused many times without damage to its viscosity or reduction in its inherent adhesion. Removal of the pad by peeling the back adhesive layer from the wall to which it has been mounted does not leave any discernable adhesive residue on the surface.

In addition, the adhesive layer is easy to clean, with the dust and other impurities needing only to be wiped off with a damp cloth.

In use, the user simply removes the back contact sheet 108, positions and adheres the pad 100 on the wall 200 or such, removes the front contact sheet 112, and positions and adheres the cell phone 300 or such, to the pad, within the broken-line outline 114. When the cell phone rings, it may be answered in “speaker-phone” style without removal from the pad, or it may be removed from the pad and replaced after conversing. It may be repeatedly removed and replaced whenever needed. The pad may be removed from the wall by simply grasping the pad at its perimeter and peeling it from the wall, and the pad may be reused on other surfaces,

It is found that those completely unfamiliar with the device are instantly disposed to use it properly when confronted with the need, due to the shape of the device and its graphics. However, additional graphics or text may alternatively be applied, such as an image or icon of a cell phone or the words “cell phone”. Users who have available numerous other locations to leave their cell phones are found far more likely to use this exemplary pad. It is found to be far superior in that regard to a simple unmarked layer of TPR material adhered to a wall.

Additional embodiments of the invention may be made to emulate in graphics and/or shape such other types of objects such as calculators, writing instruments, etc., all of which are within the invention.

While the invention has been shown and described with reference to a specific exemplary embodiment, it should be understood by those skilled in the art that various changes may be made thereto without sacrificing its material advantages. Various changes in form and detail may be made without departing from the spirit and scope of the invention, and the invention should therefore only be limited according to the following claims, including all equivalent interpretation to which they are entitled.

I claim:

1. An adhesive pad comprising:
an adhesive back layer made of a first oil-impregnated thermoplastic rubber;
an adhesive front layer made of a second oil-impregnated thermoplastic rubber;
wherein the adhesiveness of the front layer is less than the adhesiveness of the back layer.

2. The adhesive pad of claim 1 wherein each of first and second oil-impregnated thermoplastic rubbers comprises a naphthenic oil-impregnated thermoplastic rubber from the group including styrene thermoplastic elastomer, styrene-butadiene-styrene block copolymer, and styrene-ethylene-butadiene-styrene block copolymer, and wherein the adhesiveness of the front layer is less than the adhesiveness of the back layer through a difference in compounding of the first and second thermoplastic rubbers.

3. The adhesive pad of claim 2 wherein each of the first and second impregnating oils is from the group including hydrogenated naphthenic oil, mineral oil, and a combination of hydrogenated naphthenic oil and mineral oil.

4. The adhesive pad of claim 3 further comprising an intermediary layer permanently adhered to the adhesive back layer by an oil-based adhesive, and permanently adhered to the adhesive front layer by an oil-based adhesive.

5. The adhesive pad of claim 4 wherein the intermediary layer is a polymer film from the group of materials including polycarbonate, polyethylene, and polyethylene-terephthalate.

6. The adhesive of claim 5 wherein each of the first and second oil-impregnated thermoplastic rubbers comprise one-hundred parts thermoplastic rubber by weight, one-hundred to three-hundred parts hydrogenated naphthenic oil by weight, one-hundred to three-hundred parts mineral oil by weight, less than ten parts petroleum tackifier resin by weight, and one to five parts polypropylene resin by weight.

7. The adhesive pad of claim 1 wherein each of the first and second oil-impregnated thermoplastic rubbers comprises a naphthenic oil-impregnated thermoplastic rubber from the group including styrene thermoplastic elastomer, styrene-butadiene-styrene block copolymer, and styrene-ethylene-butadiene-styrene block copolymer, and wherein the adhesiveness of the front layer is less than the adhesiveness of the back layer through a difference in impregnating oil attributes in the first and second thermoplastic rubbers.

8. The adhesive pad of claim 7 wherein each of the first and second impregnating oils is from the group including hydrogenated naphthenic oil, mineral oil, and a combination of hydrogenated naphthenic oil and mineral oil.

9. The adhesive pad of claim 8 further comprising an intermediary layer permanently adhered to the adhesive back layer by an oil-based adhesive, and permanently adhered to the adhesive front layer by an oil-based adhesive.

10. The adhesive pad of claim 9 wherein the intermediary layer is a polymer film from the group of materials including polycarbonate, polyethylene, and polyethylene-terephthalate.

11. The adhesive of claim 10 wherein each of the first and second oil-impregnated thermoplastic rubbers comprises one-hundred parts thermoplastic rubber by weight, one-hundred to three-hundred parts hydrogenated naphthenic oil by weight, one-hundred to three-hundred parts mineral oil by weight, less than ten parts petroleum tackifier resin by weight, and one to five parts polypropylene resin by weight.

12. The adhesive pad of claim 1 wherein each of the first and second oil-impregnated thermoplastic rubbers comprises a naphthenic oil-impregnated thermoplastic rubber from the group including styrene thermoplastic elastomer, styrene-butadiene-styrene block copolymer, and styrene-ethylene-butadiene-styrene block copolymer, and wherein the adhesiveness of the front layer is less than the adhesiveness of the back layer through a difference in surface texture on the first and second thermoplastic rubbers.

13. The adhesive pad of claim 12 wherein each of the first and second impregnating oils is from the group including hydrogenated naphthenic oil, mineral oil, and a combination of hydrogenated naphthenic oil and mineral oil.

14. The adhesive pad of claim 13 further comprising an intermediary layer permanently adhered to the adhesive back layer by an oil-based adhesive, and permanently adhered to the adhesive front layer by an oil-based adhesive.

15. The adhesive pad of claim 14 wherein the intermediary layer is a polymer film from the group of materials including polycarbonate, polyethylene, and polyethylene-terephthalate.

16. The adhesive of claim 15 wherein each of the first and second oil-impregnated thermoplastic rubbers comprises one-hundred parts thermoplastic rubber by weight, one-hundred to three-hundred parts hydrogenated naphthenic oil by weight, one-hundred to three-hundred parts mineral oil by weight, less than ten parts petroleum tackifier resin by weight, and one to five parts polypropylene resin by weight.

17. An adhesive pad comprising:
an adhesive back layer;
an adhesive front layer; and
graphics and/or text viewable on or through the front layer and indicating that an object should be adhered to the front layer approximately centrally thereon.

18. The adhesive pad of claim 17 wherein the adhesive back layer is made of a first oil-impregnated thermoplastic rubber and the adhesive front layer is made of a second oil-impregnated thermoplastic rubber; and wherein the front layer is transparent and the pad further comprises;
an intermediary layer permanently adhered to and between the adhesive back and front layers, the intermediary layer including the graphics and/or text viewable through the transparent front layer.

19. The adhesive pad of claim 18 wherein the intermediary layer is a polymer film from the group of materials including polycarbonate, polyethylene, and polyethylene-terephthalate.

20. The adhesive pad of claim 19 wherein the graphics and/or text comprise a field having a closed peripheral border.
